(19) United States
(12) Patent Application Publication
(10) Pub. No.: US 2026/0307873 A1
(43) Pub. Date: Oct. 8, 2026

(54) DIRECTIONAL TEAR PACKAGING HAVING POLYPROPYLENE FILM

(71) Applicant: AMCOR FLEXIBLES NORTH AMERICA, INC., NEENAH, WI (US)

(72) Inventors: Bert DE SCHOENMAKER, Laarne (BE); Sara MENGHETTI, Cecina (Livorno) (IT)

(21) Appl. No.: 19/481,162

(22) PCT Filed: May 18, 2023
(86) PCT No.: PCT/US2023/022648

§ 371 Date: Nov. 3, 2025

(51) Int. Cl. B65D 75/26; B32B 1/00; B32B 27/08; B32B 27/32; B65D 75/00

(52) U.S. Cl. CPC B65D 75/26; B32B 1/00; B32B 27/08; B32B 27/32; B65D 75/008; B32B 2250/242; B32B 2307/516; B32B 2307/518; B32B 2307/7244; B32B 2439/46

(57) ABSTRACT

This disclosure concerns a sealant film comprising one or more polypropylene layers and a sealing layer comprising a polypropylene terpolymer and one or more polymers selected from polybutene-1 or a plastomer. The sealant film is a machine-direction-oriented (MDO) film comprising at least 95% by weight polypropylene. Also disclosed are multilayer packaging films comprising such sealant films and hermetically sealed packages (e.g., retort pouches) formed from the multilayer packaging film.

### TECHNICAL FIELD

The present invention is related to sealant films (e.g., machine-direction-oriented (MDO) films) and multilayer film structures incorporating such sealant films. Embodiments of the present invention are directed to multilayer films with tear straight tear performance for packaging applications.

### BACKGROUND

A typical packaging application involving the exposure of a multilayer film structure to thermal stress is retort packaging. In retort packaging, the packaged product undergoes an extended heat and pressure treatment process.

Food products are increasingly being packaged in flexible retort packages (i.e., flexible stand-up pouches) as an alternative to metal cans and glass jars. The packaging material for flexible retort packages typically includes an embedded barrier layer, an outer polymer layer adhered to one side of the barrier layer and forming the exterior surface of the package, and an inner polymer film layer adhered to the other side of the gas barrier layer and forming the interior surface of the package. This combination of layers is designed to withstand a retort process without melting or substantially degrading (i.e., leaking, delaminating). In general, retorting consists of heating the packaging container to a temperature in a range of from 100 to 135° C., at an overpressure in a range of from 0.5 to 1.1 bar, for a time period in a range of from 15 to 100 minutes.

Examples of laminates for retort packaging are disclosed in U.S. Pat. Nos. 4,310,578 A; 4,311,742 A; 4,308,084 A; 4,309,466 A; 4,402,172 A; 4,903,841 A; 5,273,797 A; 5,731,090 A; EP 1 466 725 A1; JPH 09 267 868 A; JP 2002 096 864 A; JP 2015 066 721 A; JP 2018 053 180 A; JP 2017 144 648 A; JPS 62 279 944 A; JPS 6 328 642 and JPH 10 244 641 A.

A typical example of a multilayer film structure for standard retort pouches comprises a polyethylene terephthalate exterior layer, a barrier layer, and an inner sealing layer, wherein the exterior layer comprises a printing layer, the barrier layer comprises a metal foil, or an inorganic oxide coated polymer film and the inner layer is a heat sealable polyolefin layer. The packaging material may also contain an additional polymer film layer such as a polyamide layer or the like.

However, without contesting the associated advantages of the state-of-the-art systems, there exists a need for improved sealant films and multilayer film structures for packaging, wherein the multilayer film structure is recyclable and provides straight tear performance.

### SUMMARY

Embodiments of the present invention advantageously provide sealant films and multilayer packaging films incorporating the same with easy and straight tear performance, low seal initiation temperatures, recyclability and/or compatibility with retort processing.

The disclosure provides a sealant film comprising a coextrusion of one or more polypropylene layers with a sealing layer comprising a polypropylene terpolymer and one or more polymers selected from polybutene-1 or a plastomer.

In some embodiments, the sealant film is a machine-direction-oriented (MDO) film comprising at least 90% by weight polypropylene. In some embodiments, the MDO film comprises at least 95% by weight polypropylene.

In some embodiments, the sealant film comprises a coextrusion of a sealing layer comprising a polypropylene terpolymer and one or more polymers selected from polybutene-1 or a plastomer; a core layer comprising polypropylene; and a lamination layer comprising polypropylene.

In some embodiments, the core layer comprises a polypropylene homopolymer. In some embodiments, the core layer further comprises a heterophasic polypropylene copolymer.

In some embodiments, the lamination layer comprises a heterophasic polypropylene copolymer.

In some embodiments, the sealant film comprises 15-40% by weight of the sealing layer, 70-20% by weight of the core layer and 15-40% by weight of the lamination layer.

In some embodiments, the sealing layer comprises at least 20% by weight polypropylene terpolymer.

In some embodiments, the terpolymer has a melt temperature in the range of 120-140° C., such as 120-130° C. Exemplary melt temperatures include about 120° C., about 125° C., about 130° C., about 135° C. and about 140° C.

In some embodiments, the MDO film is stretched at least 2-fold in the machine direction.

In some embodiments, the sealant film provides a seal strength of 4N/15 mm at a seal initiation temperature of 140° C. or lower, such as 130° C. or lower. Exemplary seal initiation temperatures include about 120° C., about 125° C., about 130° C., about 135° C. and about 140° C.

In some embodiments, the sealant film provides a straight tear in the machine direction.

In some embodiments, the sealant film provides a seal strength of at least 10 N, such as at least 10 N, at least 15 N or at least 20 N.

In some embodiments, the sealant film is retortable up to a temperature of at least 130° C.

The disclosure also provides a multilayer packaging film comprising a sealant film as described herein.

In some embodiments, the multilayer packaging film comprises the sealant film and a first base layer comprising a polypropylene film.

In some embodiments, the multilayer packaging film comprises at least 90% by weight polypropylene, such as at least 95% by weight polypropylene.

In some embodiments, the multilayer packaging film further comprises a second base layer comprising a polypropylene film.

In some embodiments, one or both of the first and second base layers comprise a barrier layer.

In some embodiments, one or both of the first and second base layers comprise a biaxially oriented polypropylene film (BOPP).

In some embodiments, one or both of the first and second base layers comprise a metallized biaxially oriented polypropylene film (met BOPP).

In some embodiments, the multilayer packaging film provides a straight tear in the machine direction.

In some embodiments, the multilayer packaging film provides a seal strength of 4N/15 mm at a seal initiation temperature of 140° C. or lower.

In some embodiments, the multilayer packaging film provides a seal strength of at least 10 N, such as at least 10 N, at least 15 N or at least 20 N.

The disclosure also provides a retort pouch formed from the multilayer packaging film.

### BRIEF DESCRIPTION OF THE DRAWINGS

The disclosure may be more completely understood in consideration of the following detailed description of various embodiments of the disclosure in connection with the accompanying drawings, in which:

FIG. 1A shows seal curves for an MDO stretched film according to an embodiment of the invention compared to an unoriented film and a comparative MDO stretched film;

FIG. 1B shows tear resistance for an MDO stretched film according to an embodiment of the invention compared to an unoriented film;

FIG. 1C shows tear resistance for a laminate incorporating an MDO stretched film according to an embodiment of the invention compared to a laminate incorporating an unoriented film;

FIG. 2 illustrates a cross-sectional view of an embodiment of a sealant film;

FIGS. 3 and 4 illustrate cross-sectional views of embodiments of multilayer packaging films; and

FIG. 5 illustrates a perspective view of an embodiment of a hermetically sealed package comprising a multilayer packaging film.

The drawings show some but not all embodiments. The elements depicted in the drawings are illustrative and not necessarily to scale, and the same (or similar) reference numbers denote the same (or similar) features throughout the drawings.

### DETAILED DESCRIPTION

It is believed that the packaging industry is moving toward more sustainable options, including streamlining of the materials used into narrow categories. For example, one option is to design packaging structures with high polyolefin (e.g., polypropylene) content in order to categorize the films as recyclable. Elimination of non-olefinic polymers from the packaging structures often presents deficiencies in the overall performance of the packaging structure. In the case of packaging intended for heat treatment applications such as retort or pasteurization, polyolefin polymers are more sensitive to the application temperatures.

Moreover, although easy and straight tear can be provided by machine directional orientation (MDO), this technology increases the seal initiation temperature (SIT). Thus, combining seal performance with the tear performance at the same time is difficult with polypropylene-based films.

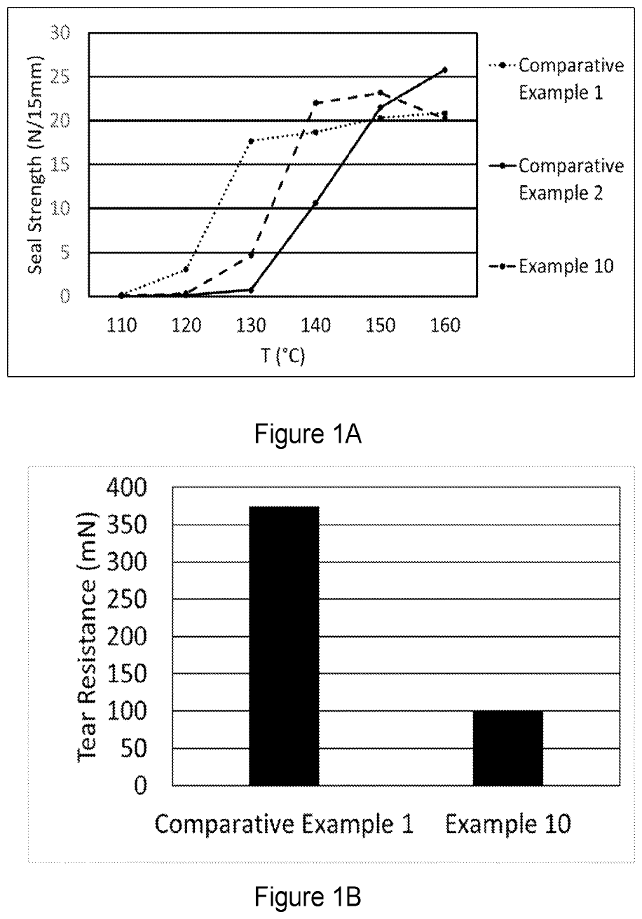

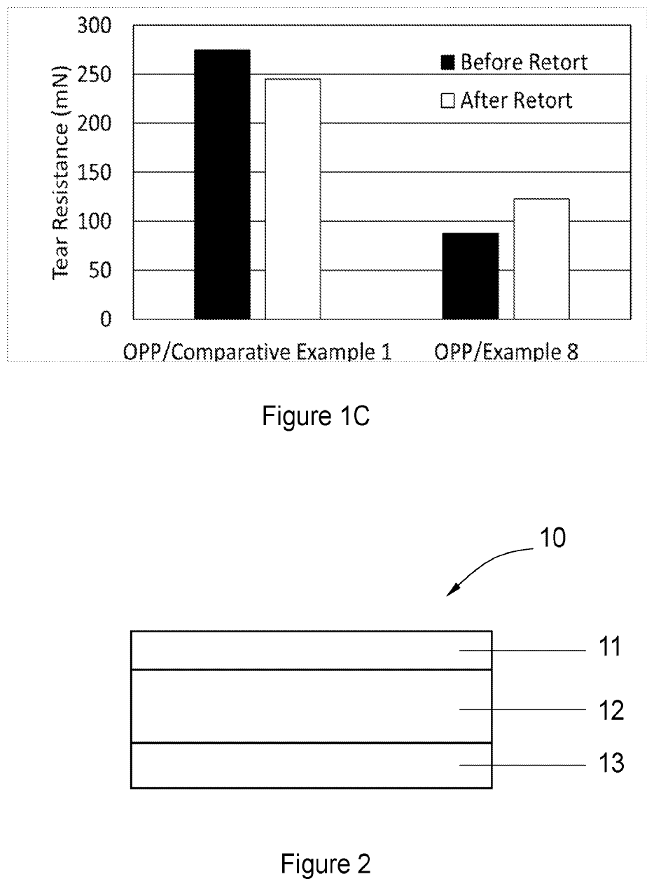

The inventors have discovered that blending polymers (e.g., polybutene-1 and/or plastomers) into polypropylene-based films provides enhanced film properties. For example, FIG. 1A shows a seal curve for MDO films. As can be seen, incorporating polymers (e.g., polybutene-1 and/or plastomers) into polypropylene-based films as shown in Sample 1-3 lowers the seal initiation temperature compared to a standard stretched polypropylene-based film. FIG. 1B shows that these Samples 1-3 also had lower tear resistance of approximately 3-fold compared to a standard stretched polypropylene-based film. FIG. 1C shows that laminates incorporating Samples 1-3 had lower tear resistance of approximately 2-fold compared to a standard stretched polypropylene-based film, and that the lower tear resistance is preserved after retort.

Accordingly, embodiments of the present invention relate to blending polymers (e.g., polybutene-1 and/or plastomers) into polypropylene-based films and subjecting such films to MDO processing to provide straight tear performance with low SIT.

### Definitions

As used herein, the term “polyolefin” generally includes polypropylene and polyethylene polymers. A polyolefin film may, for example, include an acid-modified polyolefin film obtained by graft-modifying a polyolefin polymer with an unsaturated carboxylic acid, an unsaturated carboxylic acid anhydride, an unsaturated carboxylic acid ester, or the like. Various pretreatment processes may be performed on the polyolefin films. The pretreatment processes may include any suitable process known to the skilled artisan that does not impair barrier performance. The pretreatment processes include, but are not limited to, a corona treatment, a plasma treatment, or flame treatment, or other similar processes. The polyolefin films may include an adhesive enhancement layer.

As described herein, the films described in this disclosure may be oriented. Orientation may be the result of monoaxially oriented (machine direction or transverse direction), or biaxially oriented (machine direction and transverse direction) stretching of the film, increasing the machine direction and/or transverse direction dimension and subsequently decreasing the thickness of the material. Biaxial orientation may be imparted to the film simultaneously or successively. In some embodiments, the film stretched in either or both directions at a temperature just below the melt temperature of the polymers in the film. In this manner, the stretching causes the polymer chains to “orient”, changing the physical properties of the film. At the same time, the stretching thins the film. The resulting oriented films are thinner and can have significant changes in mechanical properties such as toughness, heat resistance, stiffness, tear strength and barrier. Orientation is typically accomplished by an MDO process using heated rolls. An oriented film may be heat set (i.e., annealed) after orientation, such that the film is relatively dimensionally stable (i.e., less than 10% free shrink when heated to 130° C. for 10 minutes) under elevated temperature conditions that might be experienced during conversion of the retort film laminate (i.e., printing or laminating) or during the use of the laminate (i.e., heat sealing or retort sterilization). As used herein, “free shrink” is an unrestrained linear shrinkage that a film or layer undergoes due to exposure to elevated temperature. The shrink is irreversible and relatively rapid (i.e., evident within seconds or minutes). Shrinkage value is expressed as a percentage of the original dimension, (i.e., 100×(pre-shrink dimension−post-shrink dimension)/(pre-shrink dimension)). Free shrink can be measured using any suitable method that is capable of measuring shrinkage value differences of at least 0.2%. Free shrink can be measured using ASTM D2732-03. As described in ASTM D2732-03, free shrink is a value obtained by measuring unrestrained (i.e., free) shrink of a 10 cm square sample immersed in water at 90° C. for five seconds.

As used herein, the terms “unoriented” and “non-oriented” refer to a monolayer or multilayer film, sheet or web that is substantially free of post-extrusion orientation.

As used throughout this application, the term “copolymer” refers to a polymer product obtained by the polymerization reaction or copolymerization of at least two monomer species. The term “copolymer” is also inclusive of the polymerization reaction of three, four or more monomer species having reaction products referred to as terpolymers, quaterpolymers, etc.

As used throughout this application, the term “polypropylene” or “PP” refers to, unless indicated otherwise, propylene homopolymers or copolymers. Such copolymers of propylene include copolymers of propylene with at least one alpha-olefin and copolymers of propylene with other units or groups. The term “polypropylene” or “PP” is used without regard to the presence or absence of substituent branch groups or other modifiers. Polypropylene includes, but is not limited to, homopolymer polypropylene, polypropylene impact copolymer, polypropylene random copolymer, propylene-ethylene copolymers, ethylene-propylene copolymers, maleic anhydride grafted polypropylenes and blends of such. Various polypropylene polymers may be recycled as reclaimed polypropylene or reclaimed polyolefin.

As used herein, the term “terpolymer” refers to a copolymer produced from three different monomers. The term “polypropylene terpolymer” refers to a polypropylene molecular chain modified with two additional co-monomers in the polymerization process. Examples of the two additional co-monomers may include ethylene and/or C4-C16 α-olefins, ethylene and/or C4-C8 α-olefins, and ethylene and butylene.

As used herein, the term “heterophasic” refers to a copolymer having a second phase.

As used throughout this application, the term “polyethylene” or “PE” refers to, unless indicated otherwise, ethylene homopolymers or copolymers. Such copolymers of ethylene include copolymers of ethylene with at least one alpha-olefin and copolymers of ethylene with other units or groups such as vinyl acetate, acid groups, acrylate groups, or otherwise. The term “polyethylene” or “PE” is used without regard to the presence or absence of substituent branch groups. Polyethylene includes, but is not limited to, medium density polyethylene, high density polyethylene, low density polyethylene, linear low-density polyethylene, ultra-low density polyethylene, ethylene alpha-olefin copolymer, ethylene vinyl acetate, ethylene acid copolymers, ethylene acrylate copolymers, neutralized ethylene copolymers such as ionomer, maleic anhydride grafted polyethylene and blends of such. Various polyethylene polymers may be recycled as reclaimed polyethylene or reclaimed polyolefin.

As used throughout this application, the term “polyester” or “PET” refers to a homopolymer or copolymer having an ester linkage between monomer units. The ester linkage may be represented by the general formula [O—R—OC(O)—R′—C(O)]ₙ where R and R′ are the same or different alkyl (or aryl) group and may generally be formed from the polymerization of dicarboxylic acid and diol monomers.

As used herein, the term “polyamide” refers to a high molecular weight polymer having amide linkages (—CONH—)ₙ which occur along the molecular chain and includes “nylon” resins which are well known polymers having a multitude of uses including utility as packaging films. As used herein, “polyurethane” is generally referencing polymers having organic units joined by urethane links (—NH—(C═O)—O—).

As used throughout this application, the term “vinyl alcohol copolymer” refers to film forming copolymers of vinyl alcohol (CH₂CHOH). Examples include, but are not limited to, ethylene vinyl alcohol copolymer (EVOH), butenediol vinyl alcohol copolymer (BVOH), and polyvinyl alcohol (PVOH).

As used throughout this application, the term “ethylene vinyl alcohol copolymer”, “EVOH copolymer” or “EVOH” refers to copolymers comprised of repeating units of ethylene and vinyl alcohol. Ethylene vinyl alcohol copolymers may be represented by the general formula: [(CH₂—CH₂)ₙ—(CH₂—CH(OH))]ₙ. Ethylene vinyl alcohol copolymers may include saponified or hydrolyzed ethylene vinyl acetate copolymers. EVOH refers to a vinyl alcohol copolymer having an ethylene co-monomer and prepared by, for example, hydrolysis of vinyl acetate copolymers or by chemical reactions with vinyl alcohol. Ethylene vinyl alcohol copolymers may comprise from 28 mole percent (or less) to 48 mole percent (or greater) ethylene. The term “layer”, as used herein, refers to a building block of a film that is a structure of a single material type or a homogeneous blend of materials. A layer may be a single polymer, a blend of materials within a single polymer type or a blend of various polymers, may contain metallic materials and may have additives. Layers may be continuous with the film or may be discontinuous or patterned. A layer has an insignificant thickness (z direction) as compared to the length and width (x-y direction), and therefore is defined to have two major surfaces, the area of which are defined by the length and width of the layer. An exterior layer is one that is connected to another layer at only one of the major surfaces. In other words, one major surface of an exterior layer is exposed. An interior layer is one that is connected to another layer at both major surfaces. In other words, an interior layer is between two other layers. A layer may have sub-layers.

Similarly, the term “film”, as used herein, refers to a web built of layers and/or films, all of which are directly adjacent to and connected to each other. A film can be described as having a thickness that is insignificant as compared to the length and width of the film. A film has two major surfaces, the area of which are defined by the length and width of the film.

As used herein, the term “barrier layer” refers to a layer of a film including any material which controls a permeable element of the film. A barrier layer may provide, for example, oxygen barrier, moisture barrier, chemical barrier, heat barrier, and/or odor barrier. In one or more embodiments, the barrier layer is vacuum deposited.

Exemplary materials for the barrier layer include metal, silicon oxide (SiOₓ) or polymeric barrier materials. Exemplary metal barrier materials comprise aluminum (Al). Exemplary polymeric barrier material may include, but are not limited to, ethylene-vinyl alcohol (EVOH) copolymers; polyvinyl alcohol (PVOH) copolymers; poly(vinyl chloride); polyvinylidene polymers and copolymers, including polyvinylidene chloride; polyamides including amorphous polyamides; acrylonitrile polymers, including acrylonitrile-methyl acrylate copolymers; polyurethane engineering plastics; poly(methyl pentene) resins; ethylene-carbon monoxide copolymers; liquid crystal polymers; polyesters such as polyethylene terephthalate; polyimides, including polyether imides and polyacrylic imides; and other such polymeric materials known to have relatively low gas transmission rates.

As used herein, the term “exterior” is used to describe a film or layer that is located on one of the major surfaces of the film in which it is comprised. As used herein, the term “interior” is used to describe a film or layer that is not located on the surface of the film in which it is comprised. An interior film or layer is adjacent to another film or layer on both sides.

As used herein, a “multilayer packaging film” or “hermetically sealed package” or “retort stable package” is a film structure, or package made from the film structure, that maintains a high oxygen or moisture barrier level with little degradation after exposure to, at, or above the heat treatment temperature. The packages may be filled with product, sealed, and remain hermetically sealed, thus maintaining excellent barrier properties.

The multilayer packaging films described herein may be useful as retort or pasteurization packaging films. As used herein, a “retort packaging film” or “retort packaging” is a film, or package made from the film, that can be filled with product, sealed, and remain hermetically sealed after being exposed to a typical retort sterilization process. Typical retort sterilization is a batch process that uses temperatures in a range of from about 100° C. to about 150° C., over-pressure up to about 70 psi (483 kPa), and may have a duration from a few minutes up to several hours. Common retort processes used for products packaged in flexible films include steam or water immersion. Food or other products packaged in retort packaging film and retort sterilized can be stored at ambient conditions for extended periods of time (i.e., are shelf-stable), retaining sterility. Because the retort process degrades the films, or packages made from the films, very specialized flexible packaging films have been designed to survive the retort process.

As used herein, the term “adhesive layer” refers to a layer which has a primary function of bonding two adjacent layers together. The adhesive layers may be positioned between two layers of a multilayer film to maintain the two layers in position relative to each other and prevent undesirable delamination. Unless otherwise indicated, an adhesive layer can have any suitable composition that provides a desired level of adhesion with the one or more surfaces in contact with the adhesive layer material.

The adhesive layer may be deposited on the polyolefin film of one or more of the first base layer or the second base layer by any suitable method known to the skilled artisan. The adhesive layer may be bonding the first base layer to the sealing layer, the second base layer to the sealing layer and/or the first base layer to the second base layer. If two adhesive layers are present in the packaging film, they may be the same or different in composition and thickness.

The adhesive layer may be any conventional laminating material including but not limited to one- or two-component adhesive systems (i.e., adhesive lamination) or polymeric adhesives applied by extrusion (i.e., extrusion lamination process).

As used herein, the term “sealing layer” refers to a layer of a film, sheet, etc., involved in the sealing of the film, sheet, etc., to itself and/or to another layer of the same or another film, sheet, etc. As used herein, the terms “heat seal”, “heat sealed”, “heat sealing”, “heat sealable”, and the like, refer to both a film layer which is heat sealable to itself or other thermoplastic film layer, and the formation of a fusion bond between two polymer surfaces by conventional indirect heating means. It will be appreciated that conventional indirect heating generates sufficient heat on at least one film contact surface for conduction to the contiguous film contact surface such that the formation of a bond interface therebetween is achieved without loss of the film integrity.

As used herein, the term “seal initiation temperature” refers to a sealing temperature at which a seal strength of approximately 4 N/15 mm is achieved. Seal initiation temperature and seal strength may be evaluated using ASTM F2029.

As used herein, the term “straight tearing properties” refer to properties of a film, sheet, web, etc., that allow the film, sheet, web, etc., to easily tear in a substantially straight line. In one or more embodiments, the sealant film provides a straight tear in the machine direction. Straight tearing properties may be evaluated using a tearing method as outlined in ASTM D1938 and measuring the angle at which the tear occurs. The test sample should be prepared such that the initial cut between tongue A and tongue B of the test specimen is in the machine direction of the sample film. Upon completing the test, the angle between machine direction and the direction of tear propagation can be measured. A used herein, straight tearing properties is defined by an angle of tear propagation from machine direction of 5° or less.

FIG. 2 illustrates a cross-sectional view of an embodiment of a sealant film 10. The sealant film 10 includes a sealing layer 11, a core layer 12 and a lamination layer 13. In FIG. 2, the lamination layer 13 forms an exterior layer of the sealant film 10 and the sealing layer 11 forms the opposing exterior layer of the sealant film 10.

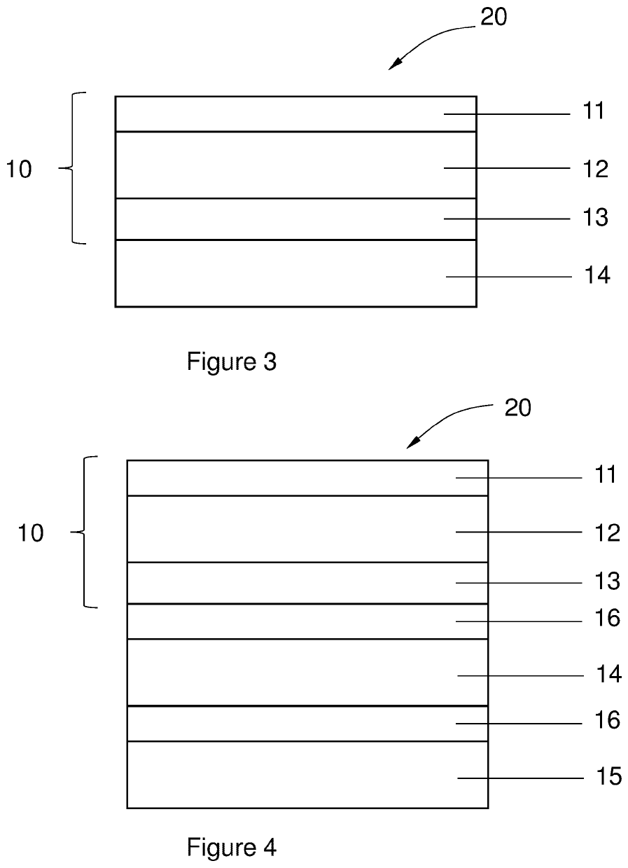

FIG. 3 illustrates a cross-sectional view of an embodiment of a multilayer packaging film 20. The multilayer packaging film 20 includes a first base layer 14 and a sealant film 10. The sealant film 10 includes a sealing layer 11, a core layer 12 and a lamination layer 13. The multilayer packaging film 20 can also include an adhesive layer (not shown) between and in direct contact with the first base layer 14 and the lamination layer 13. In FIG. 2, the first base layer 14 forms an exterior layer of the multilayer packaging film 20 and the sealing layer 11 forms the opposing exterior layer of the multilayer packaging film 20.

FIG. 4 illustrates a cross-sectional view of an embodiment of a multilayer packaging film 20. The multilayer packaging film 20 includes a first base layer 14, a second base layer 15 and a sealant film 10. The sealant film 10 includes a sealing layer 11, a core layer 12 and a lamination layer 13. The multilayer packaging film 20 includes an adhesive layer 16 between and in direct contact with the first base layer 14 and the second base layer 15, and an adhesive layer 16 between and in direct contact with the first base layer 14 and the lamination layer 13. In FIG. 4, the second base layer 15 forms an exterior layer of the multilayer packaging film 20 and the sealing layer 11 forms the opposing exterior layer of the multilayer packaging film 10. In some embodiments, one or both of the first layer 14 and second base layer 15 comprise a barrier layer on any surface.

In some embodiments, one or both of the first base layer 14 and the second base layer 15 have a thickness in a range of from 6 micron to 100 micron, including in a range of from 6 micron to 50 micron, or 10 micron to 40 micron.

In some embodiments, the adhesive layer 16 has a thickness in a range of from 2 micron to 4 micron. In some embodiments, the adhesive layer 16 has a thickness of less than or equal to 2 micron, including less than or equal to 1.9 micron, less than or equal to 1.8 micron, less than or equal to 1.7 micron, less than or equal to 1.6 micron, less than or equal to 1.5 micron, less than or equal to 1.4 micron, less than or equal to 1.3 micron, less than or equal to 1.2 micron, less than or equal to 1.1 micron, less than or equal to 1.0 micron, less than or equal to 0.9 micron, less than or equal to 0.8 micron, less than or equal to 0.7 micron, or less than or equal to 0.6 micron.

In some embodiments, the sealing layer 11 has a thickness of less than or equal to 120 micron, including less than or equal to 110 micron, less than or equal to 100 micron, less than or equal to 90 micron, less than or equal to 80 micron, less than or equal to 70 micron, less than or equal to 60 micron, including less than or equal to 50 micron, less than or equal to 40 micron, less than or equal to 30 micron, less than or equal to 20 micron, less than or equal to 10 micron, less than or equal to 5 micron, or less than or equal to 1 micron.

The first base layer and/or the second base layer may be a film and the film may be produced by any known process, for example blown film or cast film. The first base layer and/or the second base layer may be a monoaxially oriented polypropylene film (MDOPP) or a biaxially oriented polypropylene film (BOPP). The first base layer and/or the second base layer may be produced using specific polymers and may be oriented using specific conditions which optimize the heat resistance of the film. In some embodiments, the oriented polypropylene (OPP) film is formed by one or more of a sequential stretching process or a simultaneous stretching process. In some embodiments, the simultaneous stretching process is one or more of a linear motor simultaneous stretching process, a double bubble process, or a triple bubble process.

In some embodiments, the polyolefin film comprises a biaxially oriented polypropylene (BOPP) film. In one or more embodiments, the biaxially oriented polypropylene (BOPP) film is formed by a linear motor simultaneous stretching process, the biaxially oriented polypropylene (BOPP) film having a first side that is treated and not sealable and a second side that is sealable. In one or more embodiments, the biaxially oriented polypropylene (BOPP) film is formed by a triple bubble process, the biaxially oriented polypropylene (BOPP) film having a first side that is treated and not sealable and a second side that is sealable.

In various embodiments, the sealing layer comprises polypropylene with additional polymers. In some embodiments, the sealing layer comprises a polypropylene terpolymer and one or more polymers selected from polybutene-1 and/or a plastomer.

In one or more embodiments, the sealing layer comprises 10% to 40% by weight of polybutene-1 and/or a plastomer. In some embodiments, the sealing layer comprises 10% by weight of plastomer. In some embodiments, the sealing layer comprises 20% by weight of plastomer. In some embodiments, the sealing layer comprises 10% by weight of polybutene-1. In some embodiments, the sealing layer comprises 20% by weight of polybutene-1.

The sealing layer may comprise a formula of polymers designed to reduce the heat seal initiation temperature to compliment the heat resistance of the opposite exterior layer. Even though the sealing layer may have a rather low temperature softening point, the sealing layer may have enough integrity to survive the high temperatures of the retort sterilization process along with other abuses a package may endure during distribution and use.

In some embodiments, the sealing layer of the multilayer packaging film has a composition that will allow the formation of a heat seal, thus forming a hermetic package. As used herein, the term “heat seal” or “heat sealed” refers to two or more surfaces that have been bonded together by application of both heat and pressure for a short period of time, or by way of an ultrasonic energy sealing process. Heat sealing and ultrasonic sealing are well-known and commonly used processes for creating packages and are familiar to those skilled in the art.

The sealing layer is necessarily on the surface of the multilayer packaging film in order to facilitate the function of sealing. During use of the multilayer packaging film in a package, the sealing layer may be heat sealed to itself or another packaging component. During heat sealing, the sealing layer softens, allowing formation of a heat seal bond, at a sealing temperature that is lower than the temperature resistance of the opposite exterior layer of the multilayer packaging film. The sealing layer softens at a sealing temperature that is lower than the temperature resistance of the opposite exterior layer. The sealing layer softens and forms a heat seal at sealing conditions (time, temperature, and pressure) that do not cause excessive shrinking or marring on the exterior surface of the multilayer packaging film.

The multilayer packaging film is targeted to contain high amounts of polyolefin, specifically polypropylene, such that the multilayer packaging film may be acceptable for a recycling process. Polyolefins have relatively low heat resistance as compared to materials traditionally used for packaging films (i.e., polyester, aluminum foil, polyamide). The challenge met by the multilayer packaging films disclosed herein is to incorporate a sealing layer that has a low seal initiation temperature (SIT) and a high seal strength and seal toughness to survive both retort or pasteurization processing and normal distribution and handling (i.e., drop strength and burst strength). In some embodiments, the sealing layer also contains materials that are approved for food contact during retort conditions, as dictated by governmental agencies for food safety.

The multilayer packaging film may have an overall thickness from about 30 micron to about 180 micron. In some embodiments, the multilayer packaging film has an overall thickness from about 80 micron to about 140 micron.

While the structure of the multilayer packaging film and any packages made therefrom contain several different elements (sealing layer, first base layer, second base layer, adhesive, etc.) the total composition of the film or package should have high levels of a single material type (polyolefin or specifically, polypropylene) to facilitate recycling. As used herein, the term “total composition” is used to describe the entire film structure or package. Any materials, layers or components that are connected to one another in any way are part of the total composition of that article. The multilayer packaging films may have high levels of polyolefin-based polymer such as polypropylene-based polymers. The multilayer packaging films described herein, and any packages made therefrom, may be recyclable in a polypropylene recycling process when the article contains high amounts of polypropylene-based polymers.

The multilayer packaging films described herein may have a total composition that contains at least 80%, at least 85%, at least 90%, at least 95%, at least 96%, at least 97%, at least 98% or at least 99% polyolefin-based polymers by weight, promoting recyclability of the film and/or package in which it is used. Materials that are not polyolefin-based polymers are minimized. The multilayer packaging film may also have other non-polyolefin materials, such as those located in the adhesive layer.

In specific embodiments of the multilayer packaging films, the sealant film has a total composition that contains at least 80%, at least 85%, at least 90%, at least 95%, at least 96%, at least 97%, at least 98% or at least 99% polypropylene-based polymers by weight. In specific embodiments of the multilayer packaging films, the film has a total composition that contains at least 80%, at least 85%, at least 90%, at least 95%, at least 96%, at least 97%, at least 98% or at least 99% polypropylene-based polymers by weight.

Using the combination of film structure design elements as described herein, a more heat durable multilayer packaging film can be achieved. The films may be suitable to be recycled in a polyolefin-based recycling process because of the high polyolefin content. The films may have low levels (i.e., ≤5%, by weight) of, or may be essentially free from, materials such as polyester, polyamide, chlorine containing polymers and aluminum foil. As used herein, the term “essentially free of” means that that there is less than about 5%, including less than about 4%, less than about 3%, less than about 2%, less than about 1%, and less than about 0.5% from, materials such as polyester, polyamide, chlorine containing polymers and aluminum foil on an atomic basis.

The films may contain non-polyolefin-based polymers such as those used in adhesive layers, but the amount of non-polyolefin-based polymers is minimized and generally comprises less than or equal to 10% of the overall composition or less than 5% of the overall composition, by weight. The films may contain non-polymeric materials such as barrier materials, but the amount of non-polymeric materials is minimized and generally comprises less than 10% of the overall composition or less than 5% of the overall composition, by weight.

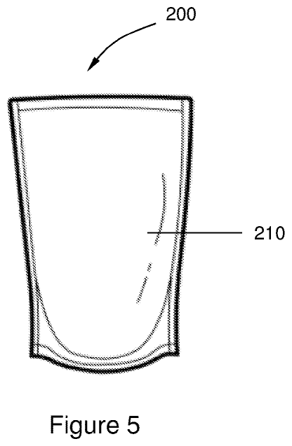

The multilayer packaging film 20 can be formed into packages, with or without other packaging components. For example, the multilayer packaging film 20 can be formed into a flexible stand-up pouch 200 as shown in FIG. 5.

The disclosure is now described with reference to the following examples.

### EXAMPLES AND DATA

Several film structures were produced as summarized in Table 1 below. All films below were made on three-layer coextrusion lines. Comparative Example 1 is not oriented, and the remaining example films are oriented. The films that are oriented were made with layer thicknesses of 45/90/45, the MDO at 3X to get to the shown thicknesses. All oriented sealant films had final layer thicknesses of sealing layer=15 micron, core layer=30 micron and lamination layer=15 micron. Comparative Example 1 had final layer thicknesses of sealing layer=45 micron, core layer=90 micron and lamination layer=45 micron.

In the below table, Bormed TD109CF is a polypropylene terpolymer; Adflex Q 109 F is a random propylene heterophasic copolymer; HC205TF is a nucleated polypropylene homopolymer; AB pp 2049 is a polypropylene based antiblock masterbatch Moplen HP556E is a polypropylene homopolymer; Moplen EP310D HP is a low fluidity polypropylene heterophasic copolymer; Queo 1007 is an ethylene based octene-1 plastomer; Queo 1001 is an ethylene based octene-1 plastomer; Adsyl 7622 XCP is an advanced polyolefin; and PB 8220 is a random copolymer of butene-1 with medium ethylene content.

TABLE 1
Identification of Sealant Films

| | Sealing Layer | Core Layer | Lamination Layer |
|---|---|---|---|
| Identification | Material | Material | Material |
| Comparative | 67% TD109CF + | 80% HP556E + | 100% EP310D |
| Example 1 | 25% Adflex | 20% EP310D HP | HP |
| | Q190F + 5% | | |
| | HC205TF + 3% | | |
| | AB PP2049 | | |
| Comparative | 67% TD109CF + | 80% HP556E + | 100% EP310D |
| Example 2 | 25% Adflex | 20% EP310D HP | HP |
| | Q190F + 5% | | |
| | HC205TF + 3% | | |
| | AB PP2049 | | |
| Comparative | 100% TD109CF | 80% HP556E + | 100% EP310D |
| Example 3 | | 20% EP310D HP | HP |
| Example 4 | 90% TD109CF + | 80% HP556E + | 100% EP310D |
| | 10% Queo 1007 | 20% EP310D HP | HP |
| Example 5 | 80% TD109CF + | 80% HP556E + | 100% EP310D |
| | 20% Queo 1007 | 20% EP310D HP | HP |
| Example 6 | 90% TD109CF + | 80% HP556E + | 100% EP310D |
| | 10% Queo 1001 | 20% EP310D HP | HP |
| Example 7 | 80% TD109CF + | 80% HP556E + | 100% EP310D |
| | 20% Queo 1001 | 20% EP310D HP | HP |
| Example 8 | 80% TD 109 CF + | 80% HP556E + | 100% EP310D |
| | 10% Vistamaxx | 20% EP310D HP | HP |
| | 3980 + 10% Queo | | |
| | 1001 | | |
| Example 9 | 80% TD 109 CF + | 80% HP556E + | 100% EP310D |
| | 20% PB 8220 | 20% EP310D HP | HP |

The sealant films in Table 1 above were tested to determine seal curves at varying temperatures. The settings for the sealing equipment were as provided in Table 2 below, and the seal curves are provided in Table 3 below. The seal curves for Comparative Example 1 and Comparative Example 2 versus Example 8 are also shown in FIG. 1A.

TABLE 2
Sealing Parameters

| | Sealing | | | |
|---|---|---|---|---|
| | Equipment | | Tensile tester | |
| Apparatus: | Kopp | Apparatus: | Hounsfield H5KS | |
| | SGPE20 | | | |
| Apparatus no: | 989/988 | Apparatus no: | 989/415 | |
| Pressure: | 400N/20 cm² | Load cell: | 250N | |
| # heated seal bars: | 2 | Pull velocity: | 300 | mm/min |
| Seal time: | 0.5 s | Pull direction: | across the seal | |
| Seal direction: | MD | Sample | 15 | mm |

| | | |
|---|---|---|
| | | width: |
| Sealed against: | Itself | |
| | (inside/inside) | |
| Protected by: | PET 12 μm | |

TABLE 3
Seal Curves

| Comparative | | | | | |
|---|---|---|---|---|---|
| Example 1 | | | | | |
| seal temperature | Seal curve (N/15 mm) | | | | |
| ° C. | m1 | m2 | m3 | Average | reference |
| 110 | 0.18 | 0.18 | 0.19 | 0.19 | no seal |
| 120 | 3.11 | 2.92 | 3.18 | 3.07 | open |
| 130 | 17.6 | 17.8 | 17.7 | 17.7 | elongation + tear |
| 140 | 18.1 | 18.9 | 19.0 | 18.7 | elongation + tear |
| 150 | 20.0 | 20.8 | 20.2 | 20.3 | elongation + tear |
| 160 | 21.1 | 20.7 | 20.8 | 20.9 | elongation + tear |

| Comparative | | | | | |
|---|---|---|---|---|---|
| Example 2 | Seal curve (N/15 mm) | | | | |
| seal temperature | | | | | reference |
| ° C. | m1 | m2 | m3 | Average | stretch |
| 110 | 0.04 | 0.03 | 0.04 | 0.04 | no seal |
| 120 | 0.13 | 0.13 | 0.11 | 0.12 | no seal |
| 130 | 0.64 | 0.64 | 0.91 | 0.73 | weak seal |
| 140 | 10.1 | 11.3 | 10.5 | 10.6 | open |
| 150 | 21.2 | 23.4 | 19.9 | 21.5 | elongation + tear/break |
| 160 | 26.6 | 26.7 | 24.1 | 25.8 | elongation + break |
| seal temperature | Seal curve (N/15 mm) | | | | |
| ° C. | m1 | m2 | m3 | Average | Comment |
| Comparative | | | | | |
| Example 3 | | | | | |
| 110 | 0.10 | 0.08 | 0.08 | 0.09 | no seal |
| 120 | 0.07 | 0.10 | 0.07 | 0.08 | no seal |
| 130 | 0.95 | 0.24 | 0.28 | 0.49 | weak seal |
| 140 | 21.5 | 17.0 | 19.7 | 19.4 | tear |
| 150 | | 25.7 | 25.6 | 25.7 | break |
| 160 | 24.7 | 25.3 | 23.2 | 24.4 | break |
| Example 4 | | | | | |
| 110 | 0.18 | 0.15 | 0.15 | 0.16 | no seal |
| 120 | 0.23 | 0.22 | 0.21 | 0.22 | no seal |
| 130 | 4.0 | 6.8 | 3.7 | 4.9 | open |
| 140 | 21.3 | 17.9 | 16.6 | 18.6 | break |
| 150 | 17.9 | 27.6 | 24.9 | 23.5 | break |
| 160 | 18.8 | 26.0 | 20.8 | 21.9 | break |
| Example 5 | | | | | |
| 110 | 0.18 | 0.17 | 0.14 | 0.16 | no seal |
| 120 | 0.42 | 0.40 | 0.46 | 0.43 | weak seal |
| 130 | 4.23 | 4.54 | 3.72 | 4.16 | open |
| 140 | 15.6 | 14.8 | 21.1 | 17.2 | break |
| 150 | 12.9 | 14.9 | 16.8 | 14.9 | coex split/break |
| 160 | 16.4 | 22.1 | 18.4 | 19.0 | break |
| Example 6 | | | | | |
| 110 | 0.23 | 0.25 | 0.21 | 0.23 | no seal |
| 120 | 0.31 | 0.27 | 0.23 | 0.27 | no seal |
| 130 | 2.62 | 3.89 | 2.28 | 2.93 | open |
| 140 | 21.6 | 19.0 | 19.6 | 20.1 | elongation + tear/break |
| 150 | 22.2 | 25.2 | 20.9 | 22.8 | elongation + break |
| 160 | 18.8 | 22.3 | 24.2 | 21.8 | elongation + break |
| Example 7 | | | | | |
| 110 | 0.29 | 0.27 | 0.32 | 0.29 | no seal |
| 120 | 0.44 | 0.45 | 0.43 | 0.44 | weak seal |
| 130 | 4.81 | 6.16 | 4.82 | 5.26 | open |
| 140 | 21.9 | 19.7 | 21.6 | 21.1 | elongation + tear/break |
| 150 | 19.1 | 21.6 | 21.2 | 20.6 | elongation + tear/break |
| 160 | 21.2 | 21.1 | 22.9 | 21.7 | elongation + break |
| Example 8 | | | | | |
| 110 | 0.13 | 0.09 | 0.09 | 0.10 | no seal |
| 120 | 0.40 | 0.32 | 0.35 | 0.36 | weak seal |
| 130 | 3.74 | 6.74 | 3.51 | 4.66 | open |
| 140 | 21.9 | 23.5 | 20.6 | 22.0 | elongation + break |
| 150 | 23.3 | 24.9 | 21.3 | 23.2 | elongation + break |
| 160 | 19.6 | 18.6 | 22.5 | 20.2 | elongation + tear/break |
| Example 9 | | | | | |
| 110 | 0.34 | 0.48 | 0.83 | 0.55 | weak seal |
| 120 | 0.91 | 0.77 | 1.01 | 0.90 | weak seal |
| 130 | 4.11 | 4.74 | 4.03 | 4.29 | open |
| 140 | 21.2 | 22.6 | 20.3 | 21.4 | elongation + tear/break |
| 150 | 18.7 | 20.1 | 20.6 | 19.8 | elongation + break |
| 160 | 20.1 | 23.8 | 20.9 | 21.6 | elongation + tear/break |

As can be seen from Table 3 and FIG. 1A, Comparative Example 1 provides a seal of about 3 N/15 mm at 120° C. This film shows how a film that is not stretched has a low SIT. The SIT is good, but the tear performance is not good because it is not oriented.

Comparative Example 2 is the oriented version of Comparative Example 1. This film shows how the SIT raises upon orienting.

Comparative Example 3 uses 100% PP terpolymer for seal. This film shows not sufficiently low SIT with only PP terpolymer.

Examples 4-7 each add 10% or 20% plastomer to the seal layer. Example 8 adds 10% elastomer and 10% plastomer. Example 9 add 20% polybutene-1. As can be seen from Table 3, Examples 4, 5, 7, 8 and 9 have seal strengths of at least 4 N/15 mm at seal initiation temperatures at or below 130° C. Example 6 also had seal strengths approaching 4 N/15 mm at 130° C. and have seal initiation temperatures between 130° C. and 140° C. In contrast, Comparative Examples 2 and 3 have weak seals at 130° C. These show that incorporating polybutene-1 or a plastomer provide the favorable reductions in the SIT.

FIG. 1A further displays that orientation raises the SIT from Comparative Example 1 (unoriented) to Comparative Example 2 (MDO). However, incorporation of the claimed polymers as in Example 8 lower the SIT compared to the MDO film of Comparative Example 2. Thus, although orientation raises the SIT, incorporating the claimed polymers helps reduce this increase in SIT.

FIG. 1B shows that the tear strength of Example 8 is around 3 times lower than tear strength of the non-stretched reference material shown in Comparative Example 1. Likewise, FIG. 1C shows that in a laminate, the tear resistance is still more than two times better for Example 8 versus Comparative Example 1. In FIG. 1C, the laminate OPP40/MDO PP60 is used to simulate the final three-ply structure OPP/OPP/MDO PP. Thus, FIGS. 1B and 1C show that MDO films comprising the claimed polymers and laminates incorporating such MDO films have superior tear performance compared to unoriented films and laminates incorporating such unoriented films.

### Embodiments

Sealant Film Embodiment A: A sealant film comprising: a sealing layer comprising a polypropylene terpolymer and one or more polymers selected from polybutene-1 or a plastomer; a core layer comprising polypropylene; and a lamination layer comprising polypropylene, wherein the sealant film is a machine-direction-oriented (MDO) film comprising at least 90% by weight polypropylene.

Sealant Film Embodiment B: The sealant film according to Embodiment A, wherein the core layer comprises a polypropylene homopolymer.

Sealant Film Embodiment C: The sealant film according to Embodiment B, wherein the core layer further comprises a heterophasic polypropylene copolymer.

Sealant Film Embodiment D: The sealant film according to any one previous Sealant Film Embodiment, wherein the lamination layer comprises a heterophasic polypropylene copolymer.

Sealant Film Embodiment E: The sealant film according to any one previous Sealant Film Embodiment, wherein the sealant film comprises in a range of from 15 to 40% by weight of the sealing layer, in a range from 70 to 20% by weight of the core layer and in a range from 15 to 40% by weight of the lamination layer.

Sealant Film Embodiment F: The sealant film according to any one previous Sealant Film Embodiment, wherein sealing layer comprises at least 20% by weight polypropylene terpolymer.

Sealant Film Embodiment G: The sealant film according to any one previous Sealant Film Embodiment, wherein the terpolymer has a melt temperature in a range from 120 to 140° C.

Sealant Film Embodiment H: The sealant film according to any one previous Sealant Film Embodiment, wherein the sealant film provides a seal strength of 4N/15 mm at a seal temperature of 140° C. or lower as measured by ASTM F2029.

Sealant Film Embodiment I: The sealant film according to any one previous Sealant Film Embodiment, wherein the sealant film provides a straight tear in the machine direction.

Sealant Film Embodiment J: The sealant film according to any one previous Sealant Film Embodiment, wherein the sealant film provides a seal strength of at least 10 N as measured by ASTM F2029.

Multilayer Packaging Film Embodiment AA: A multilayer packaging film comprising: a first base layer comprising a polypropylene film; and the sealant film of any one of the Sealant Film Embodiments laminated to the first base layer; wherein the multilayer packaging film comprises at least 90% by weight polypropylene.

Multilayer Packaging Film Embodiment BB: The multilayer packaging film according to Multilayer Packaging Film Embodiment AA, further comprising a second base layer comprising a polypropylene film.

Multilayer Packaging Film Embodiment CC: The multilayer packaging film according to any one previous Multilayer Packaging Film Embodiment, wherein one or both of the first and second base layers comprise a biaxially oriented polypropylene film (BOPP).

Multilayer Packaging Film Embodiment DD: The multilayer packaging film according to any one previous Multilayer Packaging Film Embodiment, wherein one or both of the first and second base layers comprise a barrier layer.

Multilayer Packaging Film Embodiment EE: The multilayer packaging film according to any one previous Multilayer Packaging Film Embodiment, wherein the multilayer packaging film provides a straight tear in the machine direction.

Multilayer Packaging Film Embodiment FF: The multilayer packaging film according to any one previous Multilayer Packaging Film Embodiment, wherein the multilayer packaging film provides a seal strength of 4N/15 mm at a seal initiation temperature of 140° C. or lower.

Multilayer Packaging Film Embodiment GG: The multilayer packaging film according to any one previous Multilayer Packaging Film Embodiment, wherein the multilayer packaging film provides a seal strength of at least 10 N.

Retort Pouch Embodiment: A retort pouch formed from the multilayer packaging film according to any one Multilayer Film Packaging Embodiment.

Process Embodiment: A process to produce a multilayer packaging film comprising the steps of: coextruding a sealant film comprising (i) a sealing layer comprising a polypropylene terpolymer and one or more polymers selected from polybutene-1 or a plastomer, (ii) a core layer comprising polypropylene; and (iii) a lamination layer comprising polypropylene, orienting the sealant film in the machine direction, and laminating the oriented sealant film to a first base layer comprising a polypropylene film, wherein the multilayer packaging film comprises at least 90% by weight polypropylene.

1. A sealant film comprising:
a sealing layer comprising a polypropylene terpolymer and one or more polymers selected from polybutene-1 or a plastomer;
a core layer comprising polypropylene; and
a lamination layer comprising polypropylene,
wherein the sealant film is a machine-direction-oriented (MDO) film comprising at least 90% by weight polypropylene.

2. The sealant film according to claim 1, wherein the core layer comprises a polypropylene homopolymer.

3. The sealant film according to claim 2, wherein the core layer further comprises a heterophasic polypropylene copolymer.

4. The sealant film according to claim 1, wherein the lamination layer comprises a heterophasic polypropylene copolymer.

5. The sealant film according to claim 1, wherein the sealant film comprises in a range of from 15 to 40% by weight of the sealing layer, in a range from 70 to 20% by weight of the core layer and in a range from 15 to 40% by weight of the lamination layer.

6. The sealant film according to claim 1, wherein sealing layer comprises at least 20% by weight polypropylene terpolymer.

7. The sealant film according to claim 1, wherein the terpolymer has a melt temperature in a range from 120 to 140° C.

8. The sealant film according to claim 1, wherein the sealant film provides a seal strength of 4N/15 mm at a seal temperature of 140° C. or lower as measured by ASTM F2029.

9. The sealant film according to claim 1, wherein the sealant film provides a straight tear in the machine direction.

10. The sealant film according to claim 1, wherein the sealant film provides a seal strength of at least 10 N as measured by ASTM F2029.

11. A multilayer packaging film comprising:
a first base layer comprising a polypropylene film; and
the sealant film of claim 1 laminated to the first base layer;
wherein the multilayer packaging film comprises at least 90% by weight polypropylene.

12. The multilayer packaging film according to claim 11, further comprising a second base layer comprising a polypropylene film.

13. The multilayer packaging film according to claim 11, wherein one or both of the first and second base layers comprise a biaxially oriented polypropylene film (BOPP).

14. The multilayer packaging film according to claim 11, wherein one or both of the first and second base layers comprise a barrier layer.

15. The multilayer packaging film according to claim 11, wherein the multilayer packaging film provides a straight tear in the machine direction.

16. The multilayer packaging film according to claim 11, wherein the multilayer packaging film provides a seal strength of 4N/15 mm at a seal initiation temperature of 140° C. or lower.

17. The multilayer packaging film according to claim 11, wherein the multilayer packaging film provides a seal strength of at least 10 N.

18. A retort pouch formed from the multilayer packaging film according to claim 11.

19. A process to produce a multilayer packaging film comprising the steps of:
coextruding a sealant film comprising (i) a sealing layer comprising a polypropylene terpolymer and one or more polymers selected from polybutene-1 or a plastomer, (ii) a core layer comprising polypropylene; and (iii) a lamination layer comprising polypropylene,
orienting the sealant film in the machine direction, and
laminating the oriented sealant film to a first base layer comprising a polypropylene film,
wherein the multilayer packaging film comprises at least 90% by weight polypropylene.
